(19) United States
(12) Patent Application Publication
(10) Pub. No.: US 2026/0072958 A1
(43) Pub. Date: Mar. 12, 2026

(54) AI DATA CONNECTIVITY FOR UNSTRUCTURED DATA REPOSITORIES

(71) Applicant: Snowflake Inc., Bozeman, MT (US)

(72) Inventors: Artur Piotr Chyzy, Warsaw (PL); Ganeshan Ramachandran Iyer, Redmond, WA (US); Sanjay Shrinivasan Nagamangalam, Redmond, WA (US); Aliaksei Shcharbaty, Warsaw (PL); Norbert Piotr Sienkiewicz, Warsaw (PL)

(21) Appl. No.: 19/312,623

(22) Filed: Aug. 28, 2025

Related U.S. Application Data
(60) Provisional application No. 63/692,538, filed on Sep. 9, 2024.

(51) Int. Cl. G06F 16/3329; H04L 51/02

(52) U.S. Cl. CPC G06F 16/33295; H04L 51/02

(57) ABSTRACT

Described is a system that receives data from a variety of external data repositories and identifies unstructured data within the received content. The unstructured data is processed to generate textual representations. A chat message is displayed in a user interface, prompting the first user to submit a query. Upon receiving the user's query, the system generates a modified version of the query and identifies portions of the textual representations. A content block is then generated from these portions and input into a machine learning model trained to generate responses using content blocks. The system generates a response to the user's query and displays the response within the user interface.

### CROSS-REFERENCE TO RELATED APPLICATIONS

This application claims priority to and the benefit of U.S. Provisional Patent Application No. 63/692,538, entitled “AI DATA CONNECTIVITY FOR UNSTRUCTURED DATA REPOSITORIES,” filed on Sep. 9, 2024, which is incorporated herein by reference in its entirety.

### TECHNICAL FIELD

Embodiments of the disclosure relate generally to cloud data platforms and, more specifically, to Artificial Intelligence (AI) data connectivity for unstructured data repositories.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to types of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. Indeed, the data platform may include one or more databases that are respectively maintained in association with any number of customer accounts, as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. Various ones of the appended drawings merely illustrate example embodiments of the present disclosure and should not be considered as limiting its scope.

FIG. 1 illustrates an example computing environment that includes a cloud data platform, according to some examples.

FIG. 2 is a block diagram illustrating components of a compute service manager of the cloud data platform, according to some examples.

FIG. 3 illustrates an example routine for executing a query with AI features on unstructured data, according to some examples.

FIG. 4 is an architectural diagram illustrating a process for mitigating or eliminating hallucinations during query execution, according to some examples.

FIG. 5 illustrates permissioning and indexing of the unstructured data for query processing using AI modules, according to some examples.

FIG. 6 illustrates training and use of a machine-learning program, according to some examples.

FIG. 7 illustrates a machine-learning pipeline, according to some examples.

FIG. 8 illustrates a diagrammatic representation of a machine in the form of a computer system within which a set of instructions may be executed for causing the machine to perform any one or more of the methodologies discussed herein, according to some examples.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure. The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

In the present disclosure, physical units of data that are stored in a data platform—and that make up the content of, e.g., database tables in user accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, on, etc.) what is referred to herein as an “internal storage location.” If stored external to the data platform, a given file is referred to herein as an “external file” and is referred to as being stored in (or at, on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a user account. The data platform may include one or more databases that are respectively maintained in association with any number of user accounts (e.g., accounts of one or more data providers or other types of users), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular user accounts as well. Users and/or executing processes that are associated with a given user account may, via one or more types of clients, be able to cause data to be ingested into the database, and may also be able to manipulate the data, add additional data, remove data, run queries against the data, generate views of the data, and so forth.

In an implementation of a data platform, a given database (e.g., a database maintained for a user account) may reside as an object within, e.g., a user account, which may also include one or more other objects (e.g., users, roles, privileges, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

A data platform (e.g., database system) can support data storage for one or more different organizations (e.g., customer organizations, which can be individual companies or business entities), where each individual organization can have one or more accounts (e.g., customer accounts) associated with the individual organizations, and each account can have one or more users (e.g., unique usernames or logins with associated authentication information). Additionally, an individual account can have one or more users that are designated as an administrator for the individual account. An individual account of an organization can be associated with a specific cloud platform (e.g., cloud-storage platform, such as such as AMAZON WEB SERVICES™ (AWS™), MICROSOFT® AZURE®, GOOGLE CLOUD PLATFORM™), one or more servers or data centers servicing a specific region (e.g., geographic regions such as North America, South America, Europe, Middle East, Asia, the Pacific, etc.), a specific version of a data platform, or a combination thereof. A user of an individual account can be unique to the account. Additionally, a data platform can use an organization data object to link accounts associated with (e.g., owned by) an organization, which can facilitate management of objects associated with the organization, account management, billing, replication, failover/failback, data sharing within the organization, and the like.

Traditional systems that handle unstructured data and support querying or data retrieval often face several pitfalls, particularly when dealing with large-scale, diverse data sources. Traditional systems are primarily designed to work with structured data (like databases and spreadsheets) and struggle to handle unstructured data such as PDFs, images, videos, audio, and free-form text. This data lacks a predefined schema, making it difficult for traditional systems to organize, index, and retrieve relevant information effectively.

Unstructured data often requires extensive manual intervention to clean, format, and structure the information before it can be processed. Traditional systems rely on human effort to label and organize the data, which is both time-consuming and prone to errors. This slows down the process of making unstructured data usable for analysis or query responses.

Traditional systems are not equipped with advanced AI and machine learning tools necessary to extract meaningful insights from unstructured data. They often fail to leverage modern technologies like natural language processing (NLP), optical character recognition (OCR), or machine learning to automatically interpret and generate useful information from data.

Traditional data retrieval mechanisms rely heavily on keyword-based searching or simple indexing, which are not effective in understanding the deeper context of a user's query. These systems struggle to retrieve relevant information from large volumes of unstructured data because they lack the ability to match queries to semantically related content.

When dealing with large and diverse datasets, traditional systems often face performance bottlenecks. They are not designed for efficient scaling when integrating with multiple data sources or handling continuous data updates. This limits their ability to process and retrieve information in real time, especially in environments with rapidly growing datasets.

Traditional systems often face challenges in maintaining consistent access control and privacy policies across different data sources. When importing data from external repositories, ensuring that privacy policies, permissions, and access controls are honored is difficult. This results in potential security risks or compliance issues.

These limitations make traditional systems ill-suited for efficiently handling unstructured data, leading to slow, inaccurate, and incomplete responses to queries or requests for information.

Aspects of the present disclosure address the foregoing issues, among others, with a data platform, systems, methods, and devices that leverage techniques to efficiently handle, process, and retrieve unstructured data.

The data platform is designed specifically to manage unstructured data from a variety of sources, such as PDFs, images, videos, and documents, without requiring a predefined schema. The data platform identifies unstructured data from external repositories and indexes the data, such as converting the data into textual representations that can be processed, indexed, and analyzed. This allows the system to handle diverse data types effectively, something that traditional systems struggle to achieve.

Instead of relying on manual effort to prepare data, this data platform performs chunking, parsing, and indexing unstructured data. The use of retrieval-augmented generation (RAG) ensures that the system can format and organize the data in a way that is optimized for further analysis, significantly reducing the time and effort needed to prepare data for use. This process makes the system far more efficient and scalable compared to traditional approaches.

One of the key advantages of the data platform is its integration with advanced machine learning (ML) models and AI capabilities. By converting unstructured data into a format that is compatible with ML models, such as language models (LLMs), the data platform allows for accurate and meaningful insights to be generated. The data platform applies models like optical character recognition (OCR) for text extraction from images, and natural language processing (NLP) to generate responses to queries, making the data platform far more intelligent and capable than traditional systems.

Unlike traditional systems that rely on basic keyword-based search methods, the data platform uses contextual and semantic retrieval to match user queries with the most relevant chunks of data. The data platform creates RAG content blocks, which are composed of relevant text chunks that preserve the contextual integrity of the data. These blocks are then fed into an LLM, allowing the system to generate responses that are both accurate and contextually appropriate. This approach significantly improves the relevance of the information retrieved, solving the problem of poor data retrieval mechanisms in traditional systems.

The data platform is designed to be highly scalable, handling continuous data updates from multiple external data repositories through real-time synchronization. The data platform uses a method of identifying changes in external repositories and synchronizes only the updated or new data, reducing the overhead of processing large volumes of data repeatedly. This enables the data platform to manage large datasets effectively and respond in real time, overcoming the performance bottlenecks that traditional systems face. In some cases, the data platform also syncs permissioning in real time (as further described herein), which can continuously update access controls to match those of the external repositories.

The data platform addresses the challenge of inconsistent access control by preserving and applying the privacy policies and access controls from the external data repositories. As unstructured data is imported, the data platform ensures that the same user permissions and access rights are applied in the internal environment, continuously syncing with external repositories to maintain up-to-date access policies. This ensures compliance with security and privacy regulations, solving the issue of inconsistent access handling in traditional systems.

In summary, the data platform significantly enhances the ability to handle, process, and retrieve unstructured data by automating data preparation, integrating AI-driven processing, and ensuring secure, scalable, and contextually accurate data management. This directly addresses the limitations of traditional systems and provides a much more efficient and powerful solution for working with unstructured data.

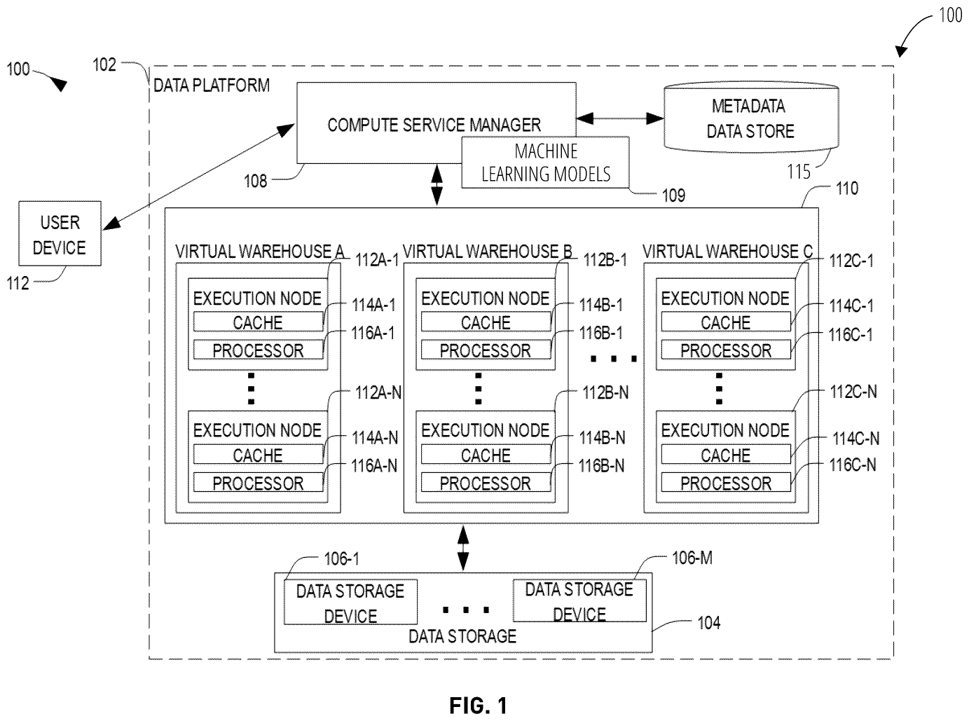

FIG. 1 illustrates an example computing environment 100 that includes a cloud data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the cloud data platform 102 comprises a three-tier architecture: a compute service manager 108 coupled to a metadata data store 115, an execution platform 110, and data storage 104. The cloud data platform 102 hosts and provides data access, management, reporting, and analysis services to multiple client accounts. Administrative users can create and manage identities (e.g., users, roles, and groups) and use permissions to allow or deny access to the identities to resources and services. The cloud data platform 102 is used for reporting and analysis of integrated data from one or more disparate sources including storage devices within the data storage 104. The data storage 104 comprises a plurality of computing machines and provides on-demand computer system resources such as data storage and computing power to the cloud data platform 102.

The compute service manager 108 includes multiple services that coordinate and manage operations of the cloud data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

As shown, the compute service manager 108 includes one or more machine learning models 109. The data platform incorporates the use of LLMs. At the core of the system is the primary LLM, responsible for generating human-like responses to user prompts. This LLM is supported by several auxiliary components, such as the document retrieval system, which fetches relevant documents from a database based on the user's query. These documents are then processed and chunked into manageable pieces to facilitate efficient retrieval and relevance assessment. The LLM uses these chunks to generate contextually rich responses, ensuring that the information provided is accurate and relevant to the user's needs.

Alongside the primary LLM, a separate citation LLM operates to verify and generate accurate citations for the information included in the responses. The citation LLM works either in parallel or in series with the primary LLM, depending on the system's design. In a parallel setup, the citation LLM receives the text generated by the primary LLM in real-time and attempts to match it with source documents, providing immediate feedback and corrections. In a series setup, the citation LLM processes the generated response after the primary LLM has completed its task. The citations are then cleaned and formatted to ensure consistency and readability. This dual-LLM approach allows the system to maintain high accuracy in content generation while ensuring that all cited information is properly verified and presented, ultimately enhancing the reliability and user experience of the system. Further details of the operation of the machine learning models 109 are discussed below.

The compute service manager 108 is also in communication with a user device 112. The user device 112 corresponds to a user of one of the multiple client accounts supported by the cloud data platform 102. In some implementations, the compute service manager 108 does not receive any direct communications from the user device 112 and only receives communications concerning jobs from a queue within the cloud data platform 102.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution nodes 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution nodes 112B-1 to 112B-N; execution node 112B-1 includes a cache 114B-1 and a processor 116B-1; and execution node 112B-N includes a cache 114B-N and a processor 116B-N. Additionally, virtual warehouse C includes execution nodes 112C-1 to 112C-N; execution node 112C-1 includes a cache 114C-1 and a processor 116C-1; and execution node 112C-N includes a cache 114C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the cloud data platform 102 based on the changing data storage/retrieval needs as well as the changing needs of the users and systems. The support of dynamic changes allows the cloud data platform 102 to scale quickly in response to changing demands on the systems and components within the cloud data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 115 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 115, execution platform 110, and data storage 104 are shown in FIG. 1 as individual discrete components. However, each of the compute service manager 108, metadata data store 115, execution platform 110, and data storage 104 may be implemented as a distributed system (e.g., distributed across multiple systems/platforms at multiple geographic locations). Additionally, each of the compute service manager 108, metadata data store 115, execution platform 110, and data storage 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

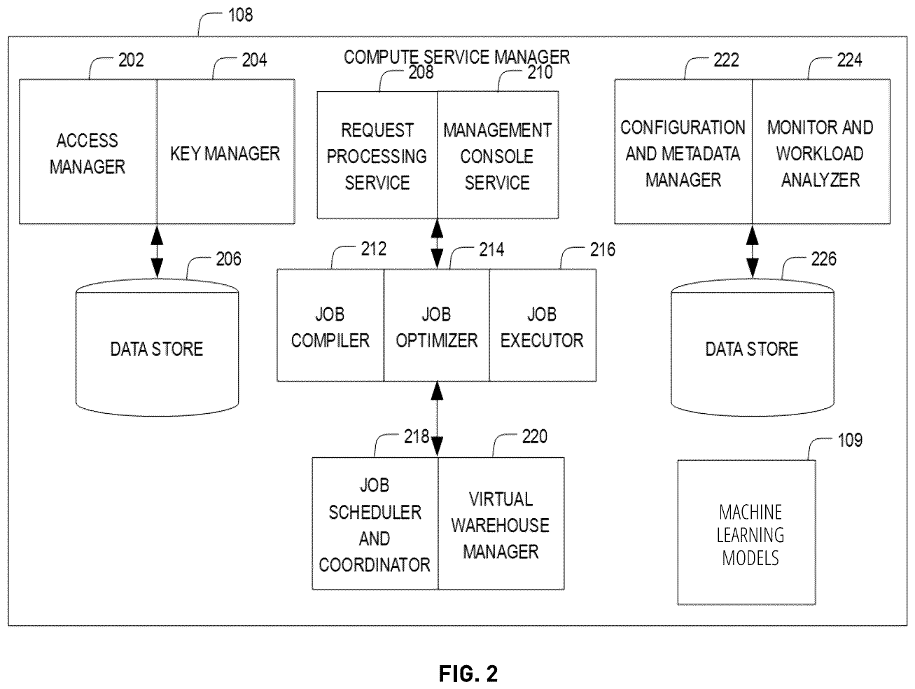

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the cloud data platform 102. For example, data store 226 may represent caches in execution platform 110, storage devices in data storage 104, the metadata data store 115, or any other storage device or system.

In addition, as mentioned above, the compute service manager 108 includes the machine learning models 109 that are responsible for many aspects of the embodiments herein. Further details regarding the functionality of the machine learning models 109 are discussed below.

In view of the disclosure above, various examples are set forth below. It should be noted that one or more features of an example, taken in isolation or combination, should be considered within the disclosure of this application.

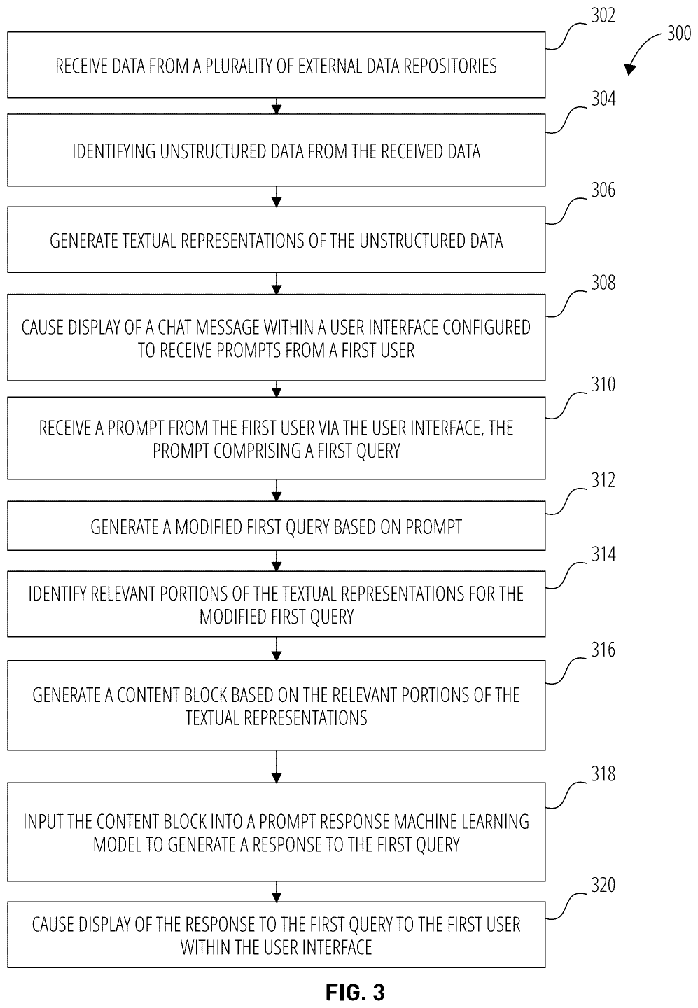

FIG. 3 illustrates an example routine 300 for executing a query with AI features on unstructured data, according to some embodiments. Although the example routine 300 depicts a particular sequence of operations, the sequence may be altered without departing from the scope of the present disclosure. For example, some of the operations depicted may be performed in parallel or in a different sequence that does not materially affect the function of the routine 300. In other examples, different components of an example device or system that implements the routine 300 may perform functions at substantially the same time or in a specific sequence.

The embodiments described herein are described as being performed by certain systems or applying certain processes, such as a particular machine learning model, but the processes described herein can be performed by one or more other or the same machine learning models.

The embodiments described herein are described for prompts or queries. However, it is appreciated that for an embodiment describing a feature applying a prompt, the embodiment can also apply to a query, and vice versa.

At operation 302, the data platform receives data from a plurality of external data repositories. The data platform receives data from a plurality of external data repositories where data is collected from various third-party sources, such as third-party content management systems.

The third-party sources can include cloud-based content management systems that organizations use to store, manage, and share data (such as unstructured data including documents, images, videos, and other files). These platforms can offer tools for collaboration, file storage, and data security. Each platform can include built-in privacy and access controls to manage user permissions for viewing or editing content.

These repositories can include unstructured data, which can include files such as PDFs, documents, images, videos, and more. The unstructured nature of the data means that the data lacks a defined schema or organization, such as schema that is ready for immediate analysis or integration into AI systems. The data platform connects to these external repositories and imports their data into the data platform's internal database, where the data can be prepared for further processing.

At operation 304, the data platform identifies unstructured data from the received data. In some cases, the data can be structured, semi-structured or unstructured. Therefore, the platform identifies the incoming data and distinguishes unstructured data such as PDFs, documents, images, audio, and video files that do not follow a predefined data model or organization.

Although examples herein apply features to unstructured data, it is appreciated that such features can be applied to semi-structured data, and even structured data such as by adding to the preexisting structure.

The data platform performs identification of data via metadata analysis or file inspection techniques. The platform may analyze attributes such as file type, file extensions, or other metadata properties to determine which files are unstructured.

For example, a platform may categorize any incoming PDFs, DOCX files, JPEGs, or MP4s as unstructured data. The system may identify files that contain rich, free-form content (like scanned documents or multimedia files), which are generally considered unstructured because they don't fit into rows and columns as structured data would. Once the unstructured data is identified, it is separated and flagged for further processing.

The identification of unstructured data can be performed by an unstructured data identification machine learning (ML) model by leveraging various classification and feature extraction techniques. The model is trained to automatically recognize unstructured data (such as documents, images, videos) from a larger dataset that may also contain structured or semi-structured data.

A supervised learning model can be trained on labeled examples of unstructured and structured data, allowing the model to learn the patterns and characteristics that distinguish different types of data. The machine learning model can be trained on a dataset that contains examples of various types of data, including structured (e.g., databases, spreadsheets), semi-structured (e.g., XML, JSON), and unstructured data (e.g., PDFs, images, videos).

During the training phase, the model learns to extract key features that are commonly associated with unstructured data, such as file formats (PDF, DOCX, JPEG), the presence of free-text content, or the absence of a predefined schema. For instance, the model might learn that unstructured data tends to have certain attributes like irregular file structures, variable content length, and multimedia content, as opposed to structured data which has well-defined columns and data types.

Once trained, the model can perform feature extraction on new incoming data. Features such as file size, format, content entropy, or metadata can be used to determine whether a file is unstructured. For instance, the model might identify that unstructured data often has a high degree of variability in text length (for documents) or pixel density (for images). Additionally, unstructured data may lack clear relational attributes or tables, and instead, contain rich, freeform content that requires more advanced processing. These extracted features allow the model to make predictions about whether the data is structured, semi-structured, or unstructured.

After extracting relevant features, the model classifies each piece of data into one of the categories (e.g., structured, semi-structured, or unstructured). This classification can be performed using a range of algorithms such as decision trees, support vector machines, or deep learning models, depending on the complexity of the data. For unstructured data, the model may rely on indicators such as the absence of clear relational structures, the presence of multimedia content, or text-based formats that are inconsistent with structured data patterns. Once the model identifies the unstructured data, the model can flag or tag those files for further processing, such as parsing, chunking, and indexing.

By leveraging machine learning to identify unstructured data, the process becomes highly scalable, automated, and adaptable. This is especially important when dealing with large and diverse datasets in enterprise environments, where manual classification would be time-consuming and error-prone. The ML model can ensure that unstructured data is accurately identified and routed for further AI processing, enabling seamless integration with machine learning workflows.

At operation 306, the data platform generates textual representations of the unstructured data. The data platform parses the text within the data files and then categorizing this text to create structured data that can be easily indexed and searched, which enables efficient retrieval of information from a large collection of uploaded documents. Although examples described herein explain the generation of textual representations, it is appreciated that other formats can be applied to the features, such as binary. The data platform can employ a multi-step process with intermediate formats (such as binary to binary to text conversions) to optimize processing power and provide enhanced accuracy in the generated textual representations. This flexible approach can allow for future improvements in processing techniques and result quality.

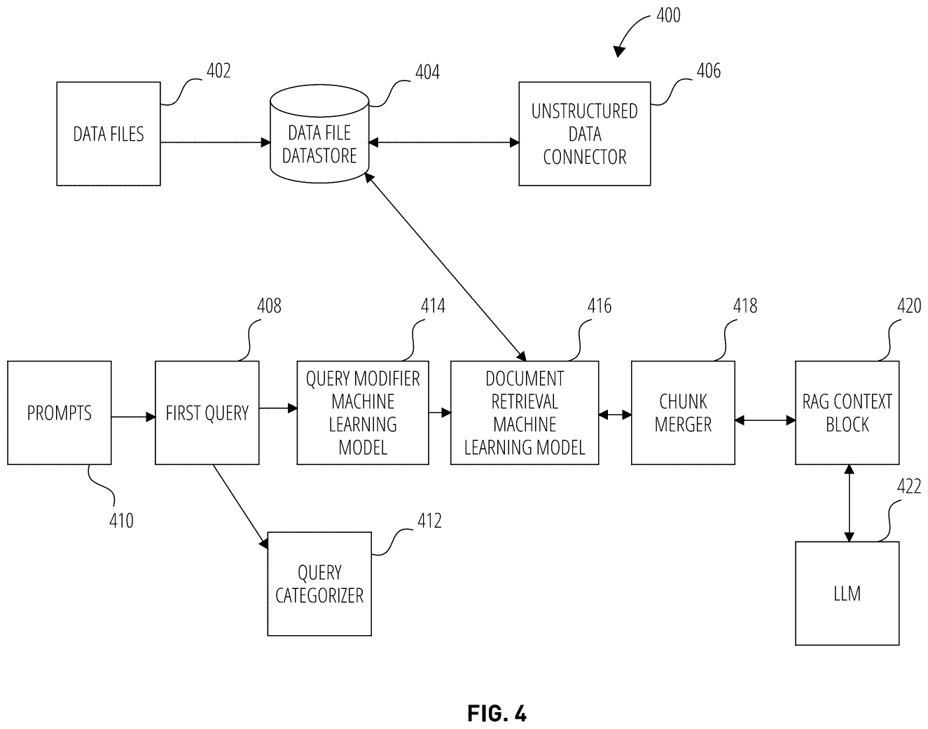

FIG. 4 is an architectural diagram 400 illustrating a process for mitigating or eliminating hallucinations during query execution, according to some embodiments. In some cases, the customer uploads a large number of files (e.g., PDFs, Word documents) to the data platform, such as the data files 402. The data platform stores such data files in the data file datastore 404.

The data platform executes an unstructured data connector 406. The unstructured data connector can apply image, video, audio processing techniques, such as optical character recognition (OCR), if the uploaded files are in formats that do not contain directly readable text (e.g., scanned images of documents). For example, the unstructured data connector can convert images of text into machine-encoded text.

The data platform parses the text extracted from the files by analyzing the text to understand its structure and content. This can include breaking the text into manageable pieces such as sentences, paragraphs, and sections.

After parsing, the data platform categorizes the text by identifying different components or sections of the documents, such as titles, headers, sections, authors, abstracts, and main content, and associating the portions of the data files to the corresponding components or sections. This structured representation helps in organizing the text for better indexing and retrieval.

The result of this process is a set of textual representations that maintain the structure and content of the original documents, which the data platform stores in the data file data store. These representations are stored in a way that facilitates efficient searching and indexing.

The textual representations are used to build a search index. The search index is a database that allows for quick and efficient retrieval of information based on keyword searches and other query parameters.

The unstructured data identification machine learning (ML) model can also be trained to generate textual representations of unstructured data by incorporating techniques that allow it to process and interpret the content of various non-text formats. This model would not only classify the type of data (e.g., image, video, audio, etc.) but also learn how to generate meaningful textual descriptions of this data, using techniques from computer vision, natural language processing (NLP), and multimodal learning.

Multimodal ML models can be designed to process multiple forms of data, such as text, images, and audio, simultaneously. The identification model can be trained to first recognize the format of the unstructured data and then apply the appropriate techniques for converting that data into text. For example, if the model identifies that a piece of data is an image, the model can use a convolutional neural network (CNN) to extract features from the image (e.g., objects, scenes, or actions). These features can then be passed through a sequence generation model, like a transformer, to create a descriptive sentence, such as “A dog is playing in the park.”

The model can also leverage transfer learning by using pre-trained models. These models have already been trained on large datasets of images paired with captions (or videos paired with descriptions) and can generate text from visual data. The unstructured data identification model could use these pre-trained models as a base and fine-tune them to generate more specific or contextually relevant textual representations for a given dataset. For example, the model can map images to relevant text, and a large language model (LLM) can refine this into a more natural language description.

In an end-to-end system, the unstructured data identification model could be trained with supervised learning using a labeled dataset. The labels can include unstructured data samples (images, audio, videos) paired with their correct textual descriptions. During training, the model learns to recognize patterns and features in the unstructured data and map them to the corresponding textual descriptions. As the model processes more examples, the model becomes proficient at generating these textual representations, even for new, unseen data types. For example, in video data, the model could be trained to extract frames, analyze them for visual cues, and then generate text that captures both the scene and any spoken language present.

In some cases, self-supervised learning can be employed to train the ML model to generate textual representations without requiring labeled data. In this case, the model could learn from the structure of the data itself, discovering relationships between visual elements and text through methods like masked language modeling (used in transformer models like BERT) or contrastive learning (used in models like CLIP). For example, the model could be trained to predict missing words in captions based on the visual data or to match images with corresponding text by learning the relationships between the two modalities.

At operation 308, the data platform causes display of a chat message within a user interface configured to receive prompts from a first user. The data platform initiates display of the interactive component through which users can input their queries or commands, allowing the system to interact with the users effectively.

The system initializes the user interface (UI) that will be used for the chat interaction. This UI is designed to be user-friendly and intuitive, ensuring that users can easily input their prompts and receive responses. A chat message is generated by the data platform, which serves as the starting point of the interaction.

The platform manages user sessions and prompts to maintain context throughout the interaction. This includes tracking the history of prompts and responses, enabling a seamless conversational flow.

At operation 310, the data platform receives a prompt from the first user via the user interface, the prompt comprising a first query. In some cases, the data platform receives a plurality of prompts from the first user. The data platform is designed to handle multiple user inputs, or “prompts,” that collectively form a history of queries from the user. The data platform maintains a session for each user, tracking the sequence of prompts within a conversation.

As shown in the example of FIG. 4, the data platform receives a plurality of prompts 410. The series of prompts provided by the user give context to subsequent prompts. Each prompt is stored in a database or in-memory data structure, indexed by session ID and timestamp. This ensures that the order of prompts is preserved, which is essential for understanding context.

Returning to FIG. 3, in between or within one of the operations of FIG. 3, the data platform assesses prompts to identify a query. In some embodiments, the data platform also categorizes the prompts via the query categorizer 412. This categorization process helps the data platform to determine whether the prompt requires data retrieval from a third-party dataset or if the prompt can be responded to by an LLM directly.

For example, the data platform classifies the prompts into three distinct categories. The first category can include a conversational prompt that do not require any search or retrieval from an indexed database. For instance, greetings or simple expressions of courtesy fall into this category. When a prompt is categorized as such a pleasantry, the data platform can immediately request an LLM to provide a quick and fast response, ensuring a seamless conversational flow without unnecessary delays.

Prompt categories can include a dataset-specific question, where these prompts specifically ask for information that needs to be retrieved from a database. For example, if a user queries specific data points or trends within a dataset, the system recognizes the need for database retrieval to generate an accurate response. In this case, the system initiates the necessary search processes, as further described herein, to fetch the relevant data from the indexed tables or databases.

Prompt categories can include questions on metadata, where this category includes queries about the dataset's metadata or general knowledge about the data. For example, if a user asks about the type of data available or how to interact with the dataset, the system categorizes such prompts as a metadata question. This type of prompt involves providing information about the dataset's structure, available fields, or how to perform specific queries, and as such, initiates the necessary search processes, as further described herein.

To efficiently handle this categorization, the data platform can apply a separate machine learning model, such as a smaller LLM, which specializes in classifying prompts into these categories. By leveraging this categorization step, the data platform can quickly determine the appropriate action for each prompt. If a prompt is classified as a pleasantry, the system can bypass the search index and directly generate a response using the LLM. For dataset-specific questions and metadata inquiries, the system proceeds with the document or text retrieval processes as described herein, ensuring that users receive accurate and relevant information based on their queries.

At operation 312, the data platform generates a modified first query based on prompt. The data platform analyzes the series of prompts to understand the overall context of the latest prompt, which can include identifying the key entities, dates, and relationships mentioned across all prompts.

In some embodiments, the data platform uses a query modifier machine learning model. As an example in FIG. 4, the data platform applies a query modifier machine learning model 414 that may include the query modifier machine learning model. The query modifier machine learning model can be trained to receive as input one or more prompts (or queries) by the user and generate a modified query, such as the first query 408, of the latest prompt from the user.

The query modifier machine learning model can include a natural language processing machine learning model. The data platform employs a natural language processing machine learning model to parse and interpret the meaning of each prompt. This can include entity recognition (e.g., identifying “quarterly earnings” and specific dates) and intent detection (e.g., understanding that the user wants a comparison).

The query modifier machine learning model synthesizes the information from all prompts to generate a modified first query by merging the individual prompts into a coherent and comprehensive query that accurately reflects the user's intent. Then the query modifier machine learning model can optimize the modified query for retrieval from the data platform, such as by rephrasing the query to match the syntax and structure expected by the underlying data retrieval system.

The query modifier machine learning model is trained to assess prompts that are not the latest prompt received from the user to determine a context for the latest prompt or query identified in the latest prompt. The query modifier machine learning model can apply multi-turns of prompts. The multi-turns refers to the query modifier machine learning model's ability to handle a sequence of user inputs or prompts, considering their context and relationships to provide coherent and contextually accurate responses.

The number of multi-turns specifies how many previous prompts the system considers when generating a response. This number can be preset, such as 3, 50, or 100, indicating the fixed count of previous prompts the system will always review. If preset to 3, the system always considers the last three prompts.

Alternatively, the number can be dynamically adjusted based on the context or complexity of the conversation, ensuring the system remains flexible and efficient. The system may start by considering the last 2 prompts but expand to the last 5 if the conversation's complexity increases or the user's queries become more interrelated.

The query modifier machine learning model can receive as input the three prompts and generate the following modified query: “Provide a report on the quarterly earnings for Q1 2023, including comparisons with Q4 2022 and Q1 2022.”

The query modifier machine learning model captures each user prompt in sequence and stores them in the user's session history. The query modifier machine learning model identifies that “quarterly earnings,” “Q1 2023,” “previous quarter,” and “same quarter last year” are key entities and time frames. The query modifier machine learning model understands that the user is looking for a comparison of earnings across multiple time periods.

Using natural language processing, the query modifier machine learning model parses each prompt, extracting relevant entities and relationships. The query modifier machine learning model synthesizes these entities into a single query that encapsulates the user's entire request.

The query modifier machine learning model generates the final modified query, ensuring the query is structured for efficient data retrieval: “Provide a report on the quarterly earnings for Q1 2023, including comparisons with Q4 2022 and Q1 2022.”

As such, the data platform can effectively handle complex, multi-turn interactions with users, providing accurate and contextually relevant responses based on a comprehensive understanding of the user's prompts.

In some embodiments, the data platform applies a skew on return feature that biases the data platform towards more recent prompts when generating a response. This means that while the data platform considers multiple turns, the platform gives higher priority or weight to the most recent inputs, ensuring the latest context or changes in the conversation are emphasized.

If a user initially asks about “quarterly earnings for Q1 2023” and later inquires about “annual earnings for 2023,” the data platform can skew its response towards the latter, more recent prompt while still considering the previous context.

In some embodiments, the data platform applies clipping on the number of turns, which limits the maximum number of previous prompts the model can consider. This helps manage computational resources and maintain response efficiency, especially in lengthy conversations. By clipping, the data platform ensures the model does not become overwhelmed by an extensive history of prompts, which might dilute the relevance of the immediate context. For example, if the clipping limit is set to 5, even if the conversation has 10 previous prompts, the system will only consider a maximum of the last 5 prompts for context.

Returning to FIG. 3, at operation 314, the data platform identifies relevant portions of the textual representations for the modified first query. The data platform assesses the modified first query to identify relevant portions of the textual representations. The data platform assesses the modified first query by inputting the modified first query into a document retrieval machine learning model 416. The document retrieval machine learning model is trained to identify portions of textual representations of documents that are relevant to inputted queries.

In some embodiments, the data platform concatenates a plurality of queries and inputs the concatenated queries into the document retrieval machine learning model. In some embodiments, the data platform generates such a concatenated query without rewriting the query. This approach ensures that the LLM has access to the entire conversation context in its original form, preserving the exact phrasing and structure of the user's inputs.

For example, if the user prompts are:
1. “Show me the quarterly earnings for Q1 2023”
2. “How does it compare to Q4 2022?”
3. “And what about the annual earnings for 2023?”

The modified first query can include “Show me the quarterly earnings for Q1 2023. How does it compare to Q4 2022?. And what about the annual earnings for 2023?”

The document retrieval machine learning model applies a semantic search over any input table previously indexed and parsed. The document retrieval machine learning model is trained to interpret and understand the semantics of the input query, enabling the document retrieval machine learning model to match the query with relevant sections of the indexed documents, ensuring that the retrieved information is contextually accurate and relevant to the user's needs.

The search index within the data platform is powered by this separate document retrieval machine learning model, which can be a small language model LLM. This model is responsible for maintaining an efficient and comprehensive index of the parsed documents.

When a query is received, the document retrieval machine learning model uses natural language processing modeling to search through the indexed data, identifying the most relevant portions based on the query's content. By leveraging the capabilities of a small LLM, the data platform can perform quick and precise searches, effectively narrowing down vast amounts of data to the most pertinent information. This dual-model approach ensures a robust and efficient retrieval process, combining the strengths of both semantic understanding and rapid indexing.

After the document retrieval process, if the data platform receives no relevant documents in response to the user's query, the data platform sends a message to the user indicating that no information was found. This ensures transparency and manages user expectations by explicitly communicating the lack of results. For instance, if a user queries specific information and the search yields no matching documents, the system generates a response such as, “Sorry, I could not find any information related to your query.” In some cases, if permissioning does not allow the user access to the document or chunk, the document retrieval process will not be able to view the document or chunk (see masking section described herein) and will provide a result with what the system can sec.

In some embodiments, the documents retrieved by the data platform come with relevancy scores, which help the data platform to assess the retrieved documents' pertinence to the query. The data platform can discard irrelevant documents based on these scores, ensuring that only the most relevant information is presented to the user.

Such discarding can be achieved by applying a minimum threshold score, where documents below a certain relevancy score are excluded. In some embodiments, the platform can retain only the top percentage or a fixed number of the highest-scoring documents. For example, if the search retrieves documents with varying relevancy scores, the system may discard those below a relevancy score of 0.7 or retain only the top 5 documents with the highest scores.

To optimize the document retrieval process, the data platform can process documents by dividing them into chunks of a specific length that the machine learning (ML) model can handle effectively. These chunks serve as the unit of retrieval, meaning the search system retrieves and processes each chunk independently. The data platform or machine learning model, that performs the retrieval, processes each of these chunks to return relevant results. To create these chunks, the data platform determines the appropriate length from the parsed documents and divides the text into contiguous segments of the desired size.

In some embodiments, the data platform creates these chunks by taking contiguous text and forming segments of a particular length that the ML model can manage, ensuring some overlap between chunks. This overlap helps maintain context across chunk boundaries, allowing the retrieval system to understand the continuity of information. This process continues until the entire document is segmented into manageable chunks.

In some embodiments, the data platform leverages the structured nature of documents, such as titles, authors, and abstracts. The data platform can create chunks based on the document's structure. For example, the data platform can create chunks that combine the abstract with the author and title or combine the introduction section with the author and title. This method allows the chunks to maintain their contextual relationships, making it easier for the retrieval system to provide relevant results.

Once the chunks are created and retrieved, the data platform merges chunks that originate from the same document to optimize the response, such as via the chunk merger module 418 in FIG. 4.

For a given query, it is beneficial to consider the entire retrieved document rather than isolated chunks. The representation of these chunks from a single document is organized in a tree structure. At the top node, key elements like the title, author, and abstract are included. Below this top node, the tree branches out into sections such as section 1, section 2, and so on. Each section can have its own title, which the system integrates into the overall document structure.

This hierarchical tree representation is beneficial because it allows the data platform to maintain context and relationships within the document. For example, if section 1 mentions “our company received 10× growth” and the original top node indicates “Snowflake quarterly report,” the system understands that the 10× growth pertains to Snowflake. This organization helps in providing coherent and contextually accurate responses.

Merging chunks based on the document enhances the system's ability to generate accurate and coherent responses. It simplifies the citation process for the large language model (LLM), as the LLM can reference entire documents rather than isolated chunks (as will be further described herein). This approach ensures that responses are contextually rich and accurate, drawing from the complete information within the document. For instance, when the LLM cites information, the data platform references the entire document, which is more natural and informative than citing fragmented chunks.

Returning to FIG. 3, at operation 316, the data platform generates a content block based on the relevant portions of the textual representations. In some cases, the data platform generates a RAG content block from the relevant portions of the textual representations. This RAG content block is used by the LLM to provide contextually accurate responses to user prompts.

The generation of the RAG content block begins with the use of a derived representation of the data files, such as a chunk, a textual representation, or a tree structure that organized the retrieved information. For example, the tree structure, created during the merging of chunks, includes details such as the title, author, abstract, and various sections of the document, maintaining their hierarchical relationships. By leveraging this tree structure, the data platform ensures that the contextual integrity of the information is preserved, making it easier for the LLM to generate coherent and relevant responses.

The RAG content block includes merged chunks of text and their associations with the original documents. Each chunk within the RAG content block is linked back to the document it came from, ensuring that the source of the information is clear, which is later used to maintain the reliability and traceability of the information used in generating responses.

Different models may have varying context limits, often defined by token budgets (the maximum number of tokens or words the model can process in a single interaction). The data platform ensures that the generated RAG content block fits within these context limits. To achieve this, the data platform manages the amount of information included in the RAG content block, balancing between providing sufficient context and staying within the token budget.

Directly adding all the RAG blocks into the LLM is impractical because it would quickly exceed the token budget. Instead, the data platform creates source identifiers for each piece of retrieved information. These identifiers, such as Ref1, Ref2, etc., are used later for citation purposes. This approach allows the LLM to reference the information without overwhelming its processing capabilities with excessive tokens. LLMs can handle simple identifiers more effectively than URLs or links to external documents, ensuring a smoother integration of the RAG content block into the response generation process.

In some cases, the data platform performs vectorization by transforming the relevant textual portions of unstructured data into mathematical representations, or vectors, that capture the semantic meaning of the text. These vectors enable the data platform to process and manipulate large amounts of text efficiently, making it easier to retrieve relevant chunks and organize them into a coherent structure for further use by the language model (LLM).

In operation 316, when the data platform generates the RAG content block, vectorization is used to represent the textual chunks derived from the unstructured data. By converting these text chunks into vectors, the system can compare and analyze the semantic similarity between different portions of the data, ensuring that the most relevant information is selected for inclusion in the RAG content block.

For instance, the platform may vectorize the title, abstract, and various sections of a document to determine which portions are most relevant to the user's query, selecting those that align best with the query's meaning.

Additionally, vectorization helps the data platform to manage the token budget constraints of the LLM. Since LLMs can have a limited capacity to process tokens (i.e., words or subwords), vector representations allow the system to group or merge semantically similar chunks while preserving the overall context and meaning. This ensures that the generated RAG content block contains sufficient, meaningful information without exceeding the model's token limit. Vectorization simplifies the process of managing the context by distilling large, unstructured texts into compact, informative vectors that are easier for the system to handle and feed into the LLM.

Moreover, the vector-based approach supports the creation of a tree structure that organizes the textual chunks hierarchically. The vectors associated with the different parts of a document (e.g., title, author, abstract, sections) are used to preserve the relationships between these elements. This hierarchical structure is vital for maintaining the contextual integrity of the information, ensuring that when the LLM generates responses, it does so based on well-organized, contextually relevant information, improving the quality and coherence of the output. In this way, vectorization is a key mechanism that enables the efficient and accurate generation of RAG content blocks for LLM-driven applications.

At operation 318, the data platform inputs the content block into a prompt response machine learning model to generate a response to the first query. The prompt response machine learning model is trained to generate responses to queries based on inputted RAG content blocks. The LLM, enhanced with the RAG content block, generates responses for the user.

As shown in FIG. 4, the data platform inputs the RAG content block generated in the previous step into a prompt response machine learning model to receive a response to the first query, ensuring that the RAG content block is effectively utilized to produce an accurate and contextually relevant response.

The RAG content block 420, which contains the relevant portions of the textual representations from the document retrieval process, is inputted into the machine learning model. This content block includes the information that the model will use to generate a response.

The prompt response machine learning model can include an LLM, such as the LLM 422 in FIG. 4, and receives as input the RAG content block. This model is trained to understand and process natural language, making the LLM capable of interpreting the context provided by the RAG block and generating a relevant response.

The LLM uses the contextual information from the RAG block to understand the nuances of the query. This includes recognizing the relationships between different chunks of text and how they relate to the user's query. Leveraging the LLM's training and the provided context, the LLM generates a response that addresses the query.

If the data platform involves multiple prompts or a multiturn conversation, the LLM can take multiple RAG content blocks to maintain continuity and context across turns. In some embodiments, the document retrieval machine learning model already considered the multiturn conversation, and thus, the RAG content block may not have to be generated for each prompt.

At operation 320, the data platform causes display of the response to the first query to the first user within the user interface. Once the response has been generated by the machine learning model, the data platform integrates the response into a user interface (UI) of the data platform. The UI displays the response to the query to the first user, such as in the chat message that is configured to receive prompts from the first user. In some cases, the data platform provides a response, such as via REST API or a stored procedure executed by one of the machine learning models as described herein (such as the document retrieval model).

Although examples described herein explain the features in certain order, such as generating textual representations when the data files are received, it is appreciated that such features can be applied in different stages, such as indexing unstructured data in response to a query that requires the application of an AI module. Another example is that certain features such as chunking, vectorizing, and RAG content block generating is performed after document retrieval, it is appreciated that such features can be performed upon receipt of the data files.

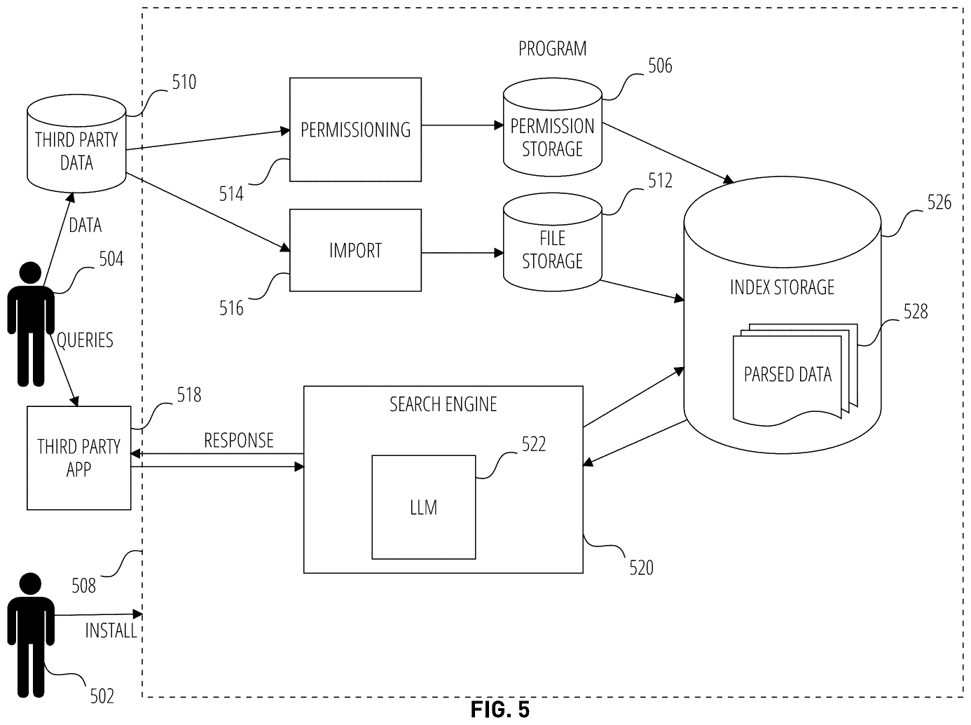

FIG. 5 illustrates permissioning and indexing of the unstructured data for query processing using AI modules, according to some examples. An administrator 502 can start by installing a program 508 (e.g., the native application or other application) that includes the unstructured data connector, which is the interface between unstructured data and the system's AI modules. This program is deployed within the organization's infrastructure or cloud environment.

During installation, the administrator configures the program to connect with various third-party data 510 where unstructured data resides, such as databases, content management systems, or cloud storage services, the data being provided by a user 504.

By installing and configuring the program 508, the administrator enables the system to automatically retrieve unstructured data via the import module 516, convert it into textual representations, index the data for efficient search and retrieval, and store such data in the file storage 512.

The third-party database can also have their own privacy policies and access controls that determine who can view or modify specific pieces of data. During the process of receiving data, access privileges are also retrieved by the permissioning module 514 and stored in the permission storage 506. Additionally, the data platform can ingest managed metadata from third-party repositories along with the data files, where such managed metadata includes business-specific classifications and tags applied by the source systems (such as high business impact, medium business impact, or low business impact designations). The data platform further incorporates dynamic data masking capabilities to protect sensitive information in real time. This includes dynamically identifying sensitive information in the unstructured data during ingestion and dynamically masking or redacting the identified sensitive information before storing the unstructured data in the data platform, ensuring that personal information such as social security numbers, salary figures, or other confidential data is protected regardless of user permissions.

When data is transferred from the external sources into the program, any user access policies—such as read/write permissions, or restrictions based on user roles—are preserved. This is achieved by mapping and applying the third-party access policies to the internal database of the program, so that even as the data is ingested and managed internally, the data retains the same security and privacy settings as it had in the external third-party database.

The user interacts with a third-party app 518 that includes a messaging interface designed to receive and process queries. This interface functions can include a chat or messaging interface, allowing the user to input their questions or requests in natural language. For example, the user might type a query such as, “Can you find the latest financial report?” or “What is the company's growth forecast for this quarter?”

Once the user inputs the query, the third-party app forwards the query to a search engine 520. This search engine is integrated into the program's backend and is capable of retrieving relevant information from an indexed database, such as the index storage 526 storing parsed data 528.

As part of this process, the search engine sends the query to a large language model (LLM), 522 which assesses the query and breaks it down to understand the user's intent. The LLM helps refine the query, ensuring that the search engine retrieves the most relevant documents or data from the available resources.

By leveraging the messaging interface in this third-party app, the user can easily interact with a sophisticated search engine that applies AI-powered language understanding, ensuring that the responses to their queries are accurate and relevant to the data stored in the system. This seamless integration allows for a smooth, intuitive querying process, with the system managing the complex backend operations.

The search engine retrieves relevant documents from the index storage, which stores the parsed and indexed data originally retrieved from the file storage. When the unstructured data is imported into the system, the data is processed and transformed into textual representations, and these representations are then stored in the file storage.

Before retrieving the requested data, the system checks permissions to ensure that the user is authorized to access the information. The index storage retrieves permissioning information from the system's permission storage, which contains the access controls imported from the original third-party repositories. The data platform also identifies both the entities (e.g., documents, files) associated with the query and the identity of the user making the request. The system ensures that the user has the appropriate access rights to view the data based on these permissions.

Once the permissioning check is completed and the relevant documents are identified, the system sends the approved information back to the search engine. The search engine can then proceed to generate a RAG content block, which is used to provide a contextually accurate response to the user's query by the LLM. In some cases, the data platform search for the list of documents or chunks first, then filter out the results based on the permissioning.

After retrieving the relevant documents and verifying permissions, the data platform proceeds to generate RAG content blocks. These content blocks are created by extracting relevant chunks of text from the identified documents and organizing them in a structured format that preserves the context of the information. The RAG content block ensures that the extracted text is concise, relevant, and linked to its source, allowing the system to maintain the accuracy and traceability of the information.

Once the RAG content block is generated, the data platform inputs the content blocks into a LLM. The LLM, which is trained to process complex queries and generate natural language responses, uses the information from the RAG content block to craft a response that directly addresses the user's query. The LLM leverages the contextual information provided by the RAG content block to generate a response that is both coherent and contextually accurate, ensuring that the user receives meaningful and relevant information.

After the response is generated by the LLM, the data platform sends the responses back to the third-party app, where the user can view the response in the messaging interface.

The data platform continuously synchronizes the file storage and/or permission storage with external third-party data repositories, ensuring that the data stays up-to-date without the need to re-fetch the entire dataset each time. In other cases, the data platform fetches or re-fetches relevant data upon query request.

Instead of importing all the data repeatedly, the data platform can check only for changes in the external repositories, such as newly added, modified, or deleted files. This approach significantly reduces the system's workload, as the approach eliminates redundant data processing and focuses solely on updates. As a result, the platform operates more efficiently, saving both time and computational resources.

By tracking changes, the data platform ensures that its internal database reflects the most current version of the data in the external repositories. In some cases, the third-party data systems only send changes to the data platform. In other cases, the system checks for changes in data files, such as via comparing the metadata or timestamps of the files (e.g., last modified dates) between the external repositories and the internal database. For instance, the system may periodically query the third-party repository to check for updates by comparing file versions, sizes, or timestamps. If discrepancies are detected, the system then imports only the modified or new files, ensuring that the internal storage stays up-to-date. In some cases, the data system tracks deletions, modifications, and/or additions.

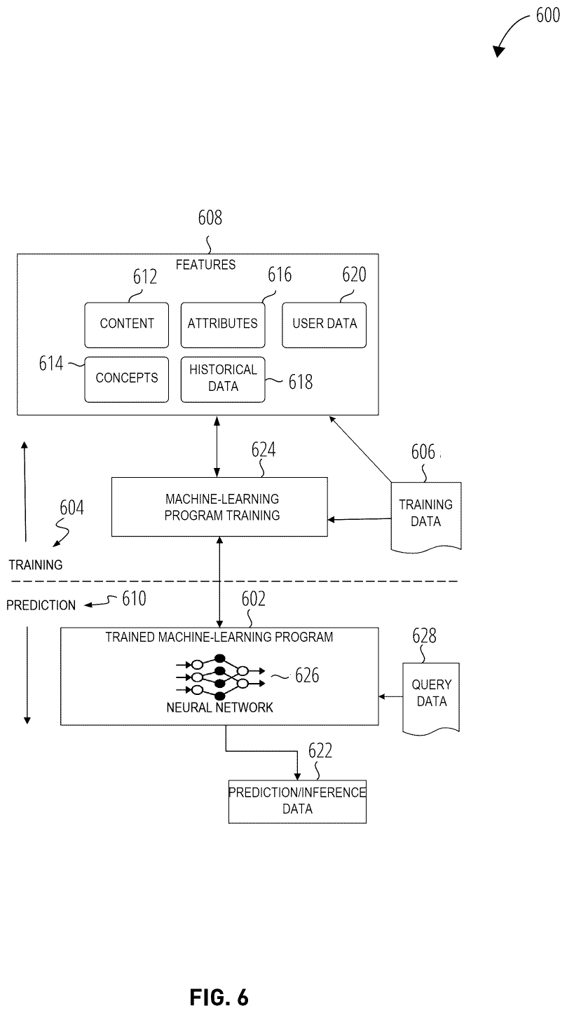

FIG. 6 illustrates further details of two example phases, namely a training phase 604 (e.g., part of the model selection and training 706) and a prediction phase 610 (part of prediction 710). Prior to the training phase 604, feature engineering 704 is used to identify features 608. This may include identifying informative, discriminating, and independent features for effectively operating the trained machine-learning program 602 in pattern recognition, classification, and regression. In some examples, the training data 606 includes labeled data, known for pre-identified features 608 and one or more outcomes. Each of the features 608 may be a variable or attribute, such as an individual measurable property of a process, article, system, or phenomenon represented by a data set (e.g., the training data 606). Features 608 may also be of different types, such as numeric features, strings, and graphs, and may include one or more of content 612, concepts 614, attributes 616, historical data 618, and/or user data 620, merely for example.

In training phase 604, the machine-learning pipeline 600 uses the training data 606 to find correlations among the features 608 that affect a predicted outcome or prediction/inference data 622.

With the training data 606 and the identified features 608, the trained machine-learning program 602 is trained during the training phase 604 during machine-learning program training 624. The machine-learning program training 624 appraises values of the features 608 as they correlate to the training data 606. The result of the training is the trained machine-learning program 602 (e.g., a trained or learned model).

Further, the training phase 604 may involve machine learning, in which the training data 606 is structured (e.g., labeled during preprocessing operations). The trained machine-learning program 602 implements a neural network 626 capable of performing, for example, classification and clustering operations. In other examples, the training phase 604 may involve deep learning, in which the training data 606 is unstructured, and the trained machine-learning program 602 implements a deep neural network 626 that can perform both feature extraction and classification/clustering operations.

In some examples, a neural network 626 may be generated during the training phase 604 and implemented within the trained machine-learning program 602. The neural network 626 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 626 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 626 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 604, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 610, the trained machine-learning program 602 uses the features 608 for analyzing query data 628 to generate inferences, outcomes, or predictions, as examples of a prediction/inference data 622. For example, during prediction phase 610, the trained machine-learning program 602 generates an output. Query data 628 is provided as an input to the trained machine-learning program 602, and the trained machine-learning program 602 generates the prediction/inference data 622 as output, responsive to receipt of the query data 628.

In some examples, the trained machine-learning program 602 may be a generative AI model. Generative AI is a term that may refer to any type of artificial intelligence that can create new content from training data 606. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like.

For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 622 can include predictions, translations, summaries, media content, and the like, or some combination thereof.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, extensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a cloud data platform 102 can include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A cloud data platform 102 may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a cloud data platform 102, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

In the present disclosure, physical units of data that are stored in a cloud data platform—and that make up the content of, e.g., database tables in customer accounts (e.g., customer users)—are referred to as micro-partitions. In different implementations, a cloud data platform can store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the cloud data platform, a given file is referred to herein as an “internal file” and may be stored in (or at, or on, etc.) what is referred to herein as an “internal storage location.” If stored external to the cloud data platform, a given file is referred to herein as an “external file” and is referred to as being stored in (or at, or on, etc.) what is referred to herein as an “external storage location.”

While example embodiments of the present disclosure reference commands in the standardized syntax of the programming language Structured Query Language (SQL), it will be understood by one having ordinary skill in the art that the present disclosure can similarly apply to other programming languages associated with communicating and retrieving data from a database.

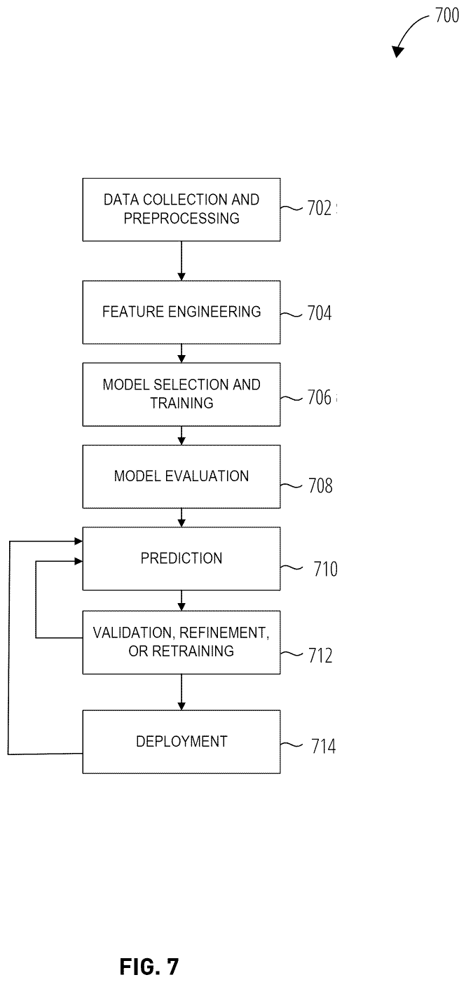

FIG. 7 depicts a machine-learning pipeline 700 and FIG. 7 illustrates training and use of a machine-learning program (e.g., model) 600. Specifically, FIG. 7 is a flowchart depicting a machine-learning pipeline 700, according to some examples. The machine-learning pipeline 700 can be used to generate a trained model, for example the trained machine-learning program 602 of FIG. 6, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, self-supervised, and reinforcement learning.

For example, supervised learning involves training a model using labeled data to predict an output for new, unseen inputs. Examples of supervised learning algorithms include linear regression, decision trees, and neural networks. Unsupervised learning involves training a model on unlabeled data to find hidden patterns and relationships in the data. Examples of unsupervised learning algorithms include clustering, principal component analysis, and generative models like autoencoders. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phases 604 as described and depicted in connection with FIG. 7, generating a trained machine-learning program 602 may include multiple phases that form part of the machine-learning pipeline 700, including for example the following phases illustrated in FIG. 7: data collection and preprocessing 702, feature engineering 704, model selection and training 706, model evaluation 708, prediction 710, validation, refinement, or retraining 712, and deployment 714, or a combination thereof.

For example, data collection and preprocessing 702 can include a phase for acquiring and cleaning data to ensure that it is suitable for use in the machine learning model. This phase may also include removing duplicates, handling missing values, and converting data into a suitable format. Feature engineering 704 can include a phase for selecting and transforming the training data 606 to create features that are useful for predicting the target variable. Feature engineering may include (1) receiving features 608 (e.g., as structured or labeled data in supervised learning) and/or (2) identifying features 608 (e.g., unstructured, or unlabeled data for unsupervised learning) in training data 606. Model selection and training 706 can include a phase for selecting an appropriate machine learning algorithm and training it on the preprocessed data. This phase may further involve splitting the data into training and testing sets, using cross-validation to evaluate the model, and tuning hyperparameters to improve performance.

In additional examples, model evaluation 708 can include a phase for evaluating the performance of a trained model (e.g., the trained machine-learning program 602) on a separate testing dataset. This phase can help determine if the model is overfitting or underfitting and determine whether the model is suitable for deployment. Prediction 710 can include a phase for using a trained model (e.g., trained machine-learning program 602) to generate predictions on new, unseen data. Validation, refinement or retraining 712 can include a phase for updating a model based on feedback generated from the prediction phase, such as new data or user feedback. Deployment 714 can include a phase for integrating the trained model (e.g., the trained machine-learning program 602) into a more extensive system or application, such as a web service, mobile app, or IoT device. This phase can involve setting up APIs, building a user interface, and ensuring that the model is scalable and can handle large volumes of data.

In view of the disclosure above, various examples are set forth below. It should be noted that one or more features of an example, taken in isolation or combination, should be considered within the disclosure of this application.

Example 1 is a system comprising: at least one hardware processor; and at least one memory storing instructions that cause the at least one hardware processor to perform operations comprising: receiving data from a plurality of external data repositories; identifying unstructured data from the received data using an unstructured data identification machine learning model, the unstructured data identification machine learning model trained to identify unstructured data from any data received by the unstructured data identification machine learning model; receiving textual representations of the unstructured data from the unstructured data identification machine learning model; causing display of a chat message within a user interface configured to receive prompts from a first user; receiving a prompt from the first user via the user interface, the prompt comprising a first query; generating a modified first query based on prompt; identifying portions of the textual representations for the modified first query; generating a content block based on the portions of the textual representations; inputting the content block into a prompt response machine learning model to generate a response to the first query, the prompt response machine learning model trained to generate responses to queries based on inputted content blocks; and causing display of the response to the first query to the first user within the user interface.

In Example 2, the subject matter of Example 1 includes, wherein the generating of the modified first query comprises applying a plurality of prompts comprising the prompt to a query modifier machine learning model to generate the modified first query, the query modifier machine learning model being trained to receive as input multiple prompts and generate a modified prompt.

In Example 3, the subject matter of Example 2 includes, wherein the first query is derived from a latest prompt of the plurality of prompts, and wherein the query modifier machine learning model is trained to modify the latest query of the multiple prompts.

In Example 4, the subject matter of Example 3 includes, wherein the identifying of the portions of the textual representations for the modified first query comprises inputting the modified first query into a document retrieval machine learning model, the document retrieval machine learning model trained to identify portions of textual representations of documents that are relevant to inputted queries.

In Example 5, the subject matter of Examples 2-4 includes, wherein the query modifier machine learning model comprises a natural language processing machine learning model trained to parse and interpret a meaning from each prompt and synthesize information interpreted from the prompts by merging the interpretations from individual prompts into the modified first query.

In Example 6, the subject matter of Examples 2-5 includes, wherein the query modifier machine learning model is configured to: perform multi-turn assessment of prompts by receiving and assessing a certain number of prompts to understand context for a latest prompt of the plurality of prompts, and apply the context when generating the modified query, wherein the operations comprise dynamically changing the number of prompts for the multi-turn assessment based on an assessment of context relevance between the latest prompt and prior prompts.

In Example 7, the subject matter of Examples 1-6 includes, wherein the operations comprise merging certain textual representations of the data into multiple data structures, and the generation of the content block is based on the data structures.

In Example 8, the subject matter of Example 7 includes, wherein the data structures comprise a tree structure, and wherein the operations comprise identifying a structure of individual data files and generating the tree structure based on the structure of the individual data file, the tree structure for the data files being used in the generation of the content block.

In Example 9, the subject matter of Examples 1-8 includes, wherein the content block comprises a Retrieval-Augmented Generation (RAG) content block.

In Example 10, the subject matter of Example 9 includes, wherein the RAG content block comprises merged chunks of the textual representations of the data and associations to source data files corresponding to each individual textual representation, the prompt response machine learning model configured to process the textual representations and associations to the data to generate responses to the queries.

In Example 11, the subject matter of Examples 9-10 includes, wherein the generating of the content block comprises identifying a token budget for the prompt response machine learning model, and adjusting the RAG content block in order to meet the token budget for the prompt response machine learning model, and wherein adjusting the contents of the RAG content block comprises changing a citation corresponding to an address for a data file to a source identifier.

In Example 12, the subject matter of Examples 9-11 includes, wherein the prompt response machine learning model determines whether the RAG content block is sufficient to generate the response to the first query, and in response to determining that the RAG content block is insufficient, identify additional portions of the textual representations, and generating the response to the first query based on the RAG content block from the portions and based on the additional portions of the textual representations.

In Example 13, the subject matter of Examples 1-12 includes, wherein the generating of the modified first query comprises creating sub-queries from the first query identified in the plurality of prompts, and wherein assessing the modified first query to identify portions of the textual representations comprises identifying relevant portion of the textual representations each of the sub-queries.

In Example 14, the subject matter of Example 13 includes, wherein the sub-queries are processed in parallel to identify portions for each of the sub-queries, the operations comprise processing each of the portions for each of the sub-queries via a large language model (LLM) to generate an overall relevant portion of the textual representations, the overall relevant portion used to generate the content block.

In Example 15, the subject matter of Examples 1-14 includes, wherein the operations comprise: identifying permissioning restrictions from the received data and associated data files for the permissioning restrictions; storing the data files with mapped permissioning restrictions; determining the permissioning restrictions associated with the portions of the textual representations; and determining whether a user of the prompt has access to the portions of the textual representations, wherein the generating of the content block, the inputting of the content block, and the causing of the display are in response to determining that the user of the prompt has access to the portions of the textual representations.

In Example 16, the subject matter of Examples 1-15 includes, wherein the operations comprise: continuously receiving updates to the data from the plurality of the external data repositories, wherein the received updates include indications of changes to the data previously received.

Example 17 is at least one machine-readable medium including instructions that, when executed by processing circuitry, cause the processing circuitry to perform operations to implement any of Examples 1-16.

Example 18 is an apparatus comprising means to implement any of Examples 1-16.

Example 19 is a method to implement any of Examples 1-16.

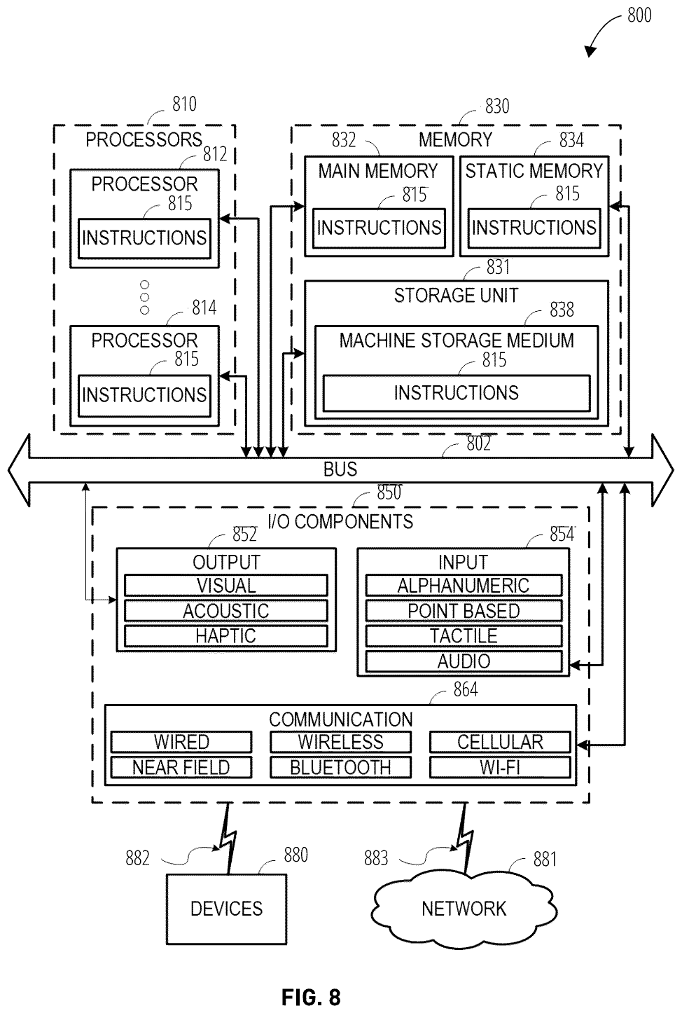

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 815 (e.g., software, a program, an application, an applet, an app, or other executable code), for causing the machine 800 to perform any one or more of the methodologies discussed herein, may be executed. For example, the instructions 815 may cause the machine 800 to implement portions of the data flows described herein (e.g., data flows described and depicted in FIG. 7). In this way, the instructions 815 transform a general, non-programmed machine into a particular machine 800 (e.g., the client device 112 of FIG. 1, the compute service manager 108 of FIG. 1, the execution platform 110 of FIG. 1) that is specially configured to carry out any one of the described and illustrated functions in the manner described herein.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 815, sequentially or otherwise, that specify actions to be taken by the machine 800. Further, while only a single machine 800 is illustrated, the term “machine” shall also be taken to include a collection of machines 800 that individually or jointly execute the instructions 815 to perform any one or more of the methodologies discussed herein.

The machine 800 includes processors 810 (such as processor 812 and processor 814), memory 830, and input/output (I/O) I/O components 850 (including output components 852 and input components 854) configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 815. The term “processor” is intended to include multi-core processors 810 that may comprise two or more independent processors (sometimes referred to as “cores”) that may execute instructions 815 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 831, all accessible to the processors 810 such as via the bus 802. The main memory 832, the static memory 834, and the storage unit 831 comprise a machine storage medium 838 that may store the instructions 815 embodying any one or more of the methodologies or functions described herein. The instructions 815 may also reside, completely or partially, within the main memory 832, within the static memory 834, within the storage unit 831, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines, such as mobile phones, will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine 800 to a network 881 via a coupler 883 or to devices 880 via a coupling 882. For example, the communication components 864 may include a network interface component or another suitable device to interface with the network 881. In further examples, the communication components 864 may include wired communication components, wireless communication components, cellular communication components, and other communication components to provide communication via other modalities. The devices 880 may be another machine or any of a wide variety of peripheral devices (e.g., a peripheral device coupled via a universal serial bus (USB)). For example, as noted above, the machine 800 may correspond to any one of the client device 112, the compute service manager 108, and the execution platform 110, and may include any other of these systems and devices.

The various memories (e.g., 830, 832, 834, and/or memory of the processor(s) 810 and/or the storage unit 831) may store one or more sets of instructions 815 and data structures (e.g., software), embodying or utilized by any one or more of the methodologies or functions described herein. These instructions 815, when executed by the processor(s) 810, cause various operations to implement the disclosed embodiments.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 881 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 881 or a portion of the network 881 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 815 may be transmitted or received over the network 881 using a transmission medium via a network interface device (e.g., a network interface component included in the communication components 864) and utilizing any one of a number of well-known transfer protocols (e.g., hypertext transfer protocol (HTTP)). Similarly, the instructions 815 may be transmitted or received using a transmission medium via the coupling 882 (e.g., a peer-to-peer coupling) to the devices 880. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 815 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one hardware processor; and
at least one memory storing instructions that cause the at least one hardware processor to perform operations comprising:
receiving data from a plurality of external data repositories;
identifying unstructured data from the received data using an unstructured data identification machine learning model, the unstructured data identification machine learning model trained to identify unstructured data from any data received by the unstructured data identification machine learning model;
receiving textual representations of the unstructured data from the unstructured data identification machine learning model;
causing display of a chat message within a user interface configured to receive prompts from a first user;
receiving a prompt from the first user via the user interface, the prompt comprising a first query;
generating a modified first query based on prompt;
identifying portions of the textual representations for the modified first query;
generating a content block based on the portions of the textual representations;
inputting the content block into a prompt response machine learning model to generate a response to the first query, the prompt response machine learning model trained to generate responses to queries based on inputted content blocks; and
causing display of the response to the first query to the first user within the user interface.

2. The system of claim 1, wherein the generating of the modified first query comprises applying a plurality of prompts comprising the prompt to a query modifier machine learning model to generate the modified first query, the query modifier machine learning model being trained to receive as input multiple prompts and generate a modified prompt.

3. The system of claim 2, wherein the first query is derived from a latest prompt of the plurality of prompts, and wherein the query modifier machine learning model is trained to modify the latest query of the multiple prompts.

4. The system of claim 3, wherein the identifying of the portions of the textual representations for the modified first query comprises inputting the modified first query into a document retrieval machine learning model, the document retrieval machine learning model trained to identify portions of textual representations of documents that are relevant to inputted queries.

5. The system of claim 2, wherein the query modifier machine learning model comprises a natural language processing machine learning model trained to parse and interpret a meaning from each prompt and synthesize information interpreted from the prompts by merging the interpretations from individual prompts into the modified first query.

6. The system of claim 2, wherein the query modifier machine learning model is configured to:
perform multi-turn assessment of prompts by receiving and assessing a certain number of prompts to understand context for a latest prompt of the plurality of prompts, and
apply the context when generating the modified query, wherein the operations comprise dynamically changing the number of prompts for the multi-turn assessment based on an assessment of context relevance between the latest prompt and prior prompts.

7. The system of claim 1, wherein the operations comprise merging certain textual representations of the data into multiple data structures, and the generation of the content block is based on the data structures.

8. The system of claim 7, wherein the data structures comprise a tree structure, and wherein the operations comprise identifying a structure of individual data files and generating the tree structure based on the structure of the individual data file, the tree structure for the data files being used in the generation of the content block.

9. The system of claim 1, wherein the content block comprises a Retrieval-Augmented Generation (RAG) content block.

10. The system of claim 9, wherein the RAG content block comprises merged chunks of the textual representations of the data and associations to source data files corresponding to each individual textual representation, the prompt response machine learning model configured to process the textual representations and associations to the data to generate responses to the queries.

11. The system of claim 9, wherein the generating of the content block comprises identifying a token budget for the prompt response machine learning model, and adjusting the RAG content block in order to meet the token budget for the prompt response machine learning model, and wherein adjusting the contents of the RAG content block comprises changing a citation corresponding to an address for a data file to a source identifier.

12. The system of claim 9, wherein the prompt response machine learning model determines whether the RAG content block is sufficient to generate the response to the first query, and in response to determining that the RAG content block is insufficient, identify additional portions of the textual representations, and generating the response to the first query based on the RAG content block from the portions and based on the additional portions of the textual representations.

13. The system of claim 1, wherein the generating of the modified first query comprises creating sub-queries from the first query identified in the plurality of prompts, and wherein assessing the modified first query to identify portions of the textual representations comprises identifying relevant portion of the textual representations each of the sub-queries.

14. The system of claim 13, wherein the sub-queries are processed in parallel to identify portions for each of the sub-queries, the operations comprise processing each of the portions for each of the sub-queries via a large language model (LLM) to generate an overall relevant portion of the textual representations, the overall relevant portion used to generate the content block.

15. The system of claim 1, wherein the operations comprise:
identifying permissioning restrictions from the received data and associated data files for the permissioning restrictions;
storing the data files with mapped permissioning restrictions;
determining the permissioning restrictions associated with the portions of the textual representations; and
determining whether a user of the prompt has access to the portions of the textual representations, wherein the generating of the content block, the inputting of the content block, and the causing of the display are in response to determining that the user of the prompt has access to the portions of the textual representations.

16. The system of claim 1, wherein the operations comprise:
continuously receiving updates to the data from the plurality of the external data repositories, wherein the received updates include indications of changes to the data previously received.

17. A method performed by at least one hardware processor, the method comprising:
receiving data from a plurality of external data repositories;
identifying unstructured data from the received data using an unstructured data identification machine learning model, the unstructured data identification machine learning model trained to identify unstructured data from any data received by the unstructured data identification machine learning model;
receiving textual representations of the unstructured data from the unstructured data identification machine learning model;
causing display of a chat message within a user interface configured to receive prompts from a first user;
receiving a prompt from the first user via the user interface, the prompt comprising a first query;
generating a modified first query based on prompt;
identifying portions of the textual representations for the modified first query;
generating a content block based on the portions of the textual representations;
inputting the content block into a prompt response machine learning model to generate a response to the first query, the prompt response machine learning model trained to generate responses to queries based on inputted RAG content blocks; and
causing display of the response to the first query to the first user within the user interface.

18. The method of claim 17, wherein generating the modified first query comprises applying a plurality of prompts comprising the prompt to a query modifier machine learning model to generate the modified first query, the query modifier machine learning model being trained to receive as input multiple prompts and generate a modified prompt.

19. The method of claim 17, comprising:
merging certain textual representations of the data into multiple data structures, and the generation of the content block is based on the data structures.

20. Computer-storage media comprising instructions that, when executed by one or more processors of a machine, configure the machine to perform operations comprising:
receiving data from a plurality of external data repositories;
identifying unstructured data from the received data using an unstructured data identification machine learning model, the unstructured data identification machine learning model trained to identify unstructured data from any data received by the unstructured data identification machine learning model;
receiving textual representations of the unstructured data from the unstructured data identification machine learning model;
causing display of a chat message within a user interface configured to receive prompts from a first user;
receiving a prompt from the first user via the user interface, the prompt comprising a first query;
generating a modified first query based on prompt;
identifying portions of the textual representations for the modified first query;
generating a content block based on the portions of the textual representations;
inputting the content block into a prompt response machine learning model to generate a response to the first query, the prompt response machine learning model trained to generate responses to queries based on inputted RAG content blocks; and
causing display of the response to the first query to the first user within the user interface.
